(19) United States
(12) Patent Application Publication
(10) Pub. No.: US 2013/0008393 A1
(43) Pub. Date: Jan. 10, 2013

(54) C&D Bandage Harness for Canines and Felines

(76) Inventors: Denise Backman, Deer Park, NY (US); Craig Backman, Deer Park, NY (US)

(21) Appl. No.: 13/465,390

(22) Filed: May 7, 2012

Related U.S. Application Data
(60) Provisional application No. 61/571,980, filed on Jul. 9, 2011.

(51) Int. Cl. A61D 9/00

(52) U.S. Cl. 119/850

(57) ABSTRACT

A harness device with detachable stockinet that aids in the protection of elbow and leg wounds on canines, felines, and like animals, allowing the paw to remain unwrapped. The device comprises of two straps that connect around the animals' withers or back that are adjustable; a tubular body part that fits around the animals' leg, just above the elbow; and a detachable stockinet that connects to the body part with Velcro, that can be changed out to keep clean material on the wound. The device is fitted per each leg for a secure fit, with only the rear leg harness to be worn with a securely fitted harness found in most pet stores. Only one leg is needed for proper fitting of bandage harness.

### CROSS REFERENCE TO PRIOR ART PATENT APPLICATION

This application claims priority to Provisional Application No. 61/571,980, filed Jul. 9, 2011, called Harness Bandage for Canine Elbow and Leg Wounds.

### BACKGROUND OF THE INVENTION

When a canine or feline has a leg or elbow injury or wound, a veterinarian will wrap the animal's leg completely with bandages, from the chest, all the way down to and including the paw, to ensure the bandage does not fall down to expose the wound. Enclosing the paw in a bandage causes the risk of irritation to the insides of the paw inter-digital area due to moisture buildup due to heat or the bandage getting wet, which in turns causes the animal to chew at the bandage surrounding the paw in order to instinctively lick at the irritation. Also, due to the shape of the animal's leg, whereas the top part is larger while declining in size towards the paw, the bandage within a short time, will start to fall, once again, exposing the wound. The present invention will keep the bandage up around the wound as well as free the paw completely from any bandage by means of a harness put on the animal's leg close to the chest with two straps connected by a buckle, for adjustment, across the animal's withers or connects to a harness for a rear leg wound application. The bandage applied by a veterinarian to cover the wound is attached to the harness with the adhesive side.

### Field of Invention: Veterinarian Science

### BRIEF SUMMARY OF THE INVENTION

In accordance with the present invention, C&D Bandage Harness is provided compromising; A harness that encases the animal's leg from the chest to right above the elbow, which contain elastic strips to allow for stretch around the leg; One strap going from the outside of the leg along the lateral brachium, ending over the withers, with another strap coming up under and around the opposite pectoral area to meet at the withers. A buckle attaches the two straps that is adjustable per girth of the animal's full circumference of their thorax or attached to a well-fitted harness for rear leg bandage harness application. The apparatus is not interchangeable amongst the legs in order to have proper fit for application of said invention. The invention must consist of a front left leg bandage harness; or a front right leg bandage harness; or a left rear leg bandage harness; or a right rear leg bandage harness; yet only one leg is needed. Furthermore, the bandage harness contains a detachable stockinet, which attaches with a loop and hook fastener most known as Velcro, for clean dressing changes and exists in a several sizes. Extra-small for canine breeds such as the Chihuahua, Miniature Pinscher, and Felines; Small for canine breeds such as the Beagle or small Poodle; Medium for canine breeds such as the Labrador and Doberman; Large for canine breeds such as the Rottweiler or American Staffordshire Bull Dog; Extra-Large for canine breeds such as the St. Bernard and Bull Mastiff. Sizes are based on circumference of harness placed around the animal's leg and added length of straps per girth of the animal. For instance, and canine breed such as the Corky or Havenese can use a small to medium size, depending on the size of the canine.

### CROSS REFERENCE TO PRIOR PATENT APPLICATIONS

| Appl. No. | Pub. No. | Filing Date | |
|---|---|---|---|
| 11/880,053 | US 2008/0022945 A1 | Jul. 19, 2007 | Hughes |
| 11/595,871 | US 2008/0173258 | Jan. 22, 2007 | Franco |
| 12/764,538 | US 2010/0263602 A1 | Apr. 21, 2010 | Cho |
| 11/829,245 | US 2008/0223311 A1 | Jul. 27, 2007 | Ito |
| 12/776,574 | US 2011/0271913 A1 | May 10, 2010 | Min |

### DESCRIPTION OF PRIOR PATENT APPLICATIONS INCLUDING INFORMATION TO DISCLOSE

The prior art by Hughes, U.S. 2008/0022945, application Ser. No. 11/880,053, and Franco, U.S. 2008/0173258, application Ser. No. 11/595,871, have some similarities to the C&D Bandage Harness yet all work to accomplish different results. The prior art known as a Protective Foot and Leg Cover Guard for Wounds and Allergies, US2008/0173258 A1, Ser. No. 11/595,871 is used to cover a bandaged leg and/or foot and prevents the animal from licking at the wound, or biting, scratching, or removing bandages if used. It is a sock-like garment where as the animal's leg slides into it, with an adjustable clasp that joins in back of the neck, made of durable nylon, which is not completely breathable material causing moisture build-up which creates irritation of covered paw. The prior art, known as Bandages for Animals, US2008/0022945 A1, Ser. No. 11/880,053 is a bandage system for an animal that has at least two legs. One stockinet fits onto one leg while another stockinet fits onto the other leg, with an attachment, known as the support member that attaches to one stockinet or bandage, travels over the animal's back and connects to the second stockinet or bandage. This apparatus is used as the bandage for the animal that will not fall down and keep the wound covered, yet two legs are needed in order for this device to work properly. The prior art known as, The Pet Harness, U.S. 2010/0263602 A1, Ser. No. 12/764,538, is an example of an apparatus to be used in conjunction with the rear leg bandage harness for a secure fit. Two other examples of harnesses that can be used in conjunction with the bandage harness for a rear leg application are the Pet Harness, U.S. 2008/0223311 A1, Ser. No. 11/829,245 and the Dog Harness, U.S. 2011/0271913 A1, Ser. No. 12/776,574, whereas the harness fit is snug to the chest, aiding in a secure fit.

### BRIEF DESCRIPTION OF THE SEVERAL VIEWS OF THE DRAWINGS

FIG. 1 is the outside view of the bandage harness invention.

FIG. 2 is the inside view of the bandage harness invention.

FIG. 3 is the view of the Bandage Harness invention with the application of bandages, gauze, net wrap, and tape.

FIG. 4a is the left side view of the Bandage Harness invention Front Leg application, as it would look when placed on an animal's left front leg.

FIG. 4b is the right side view of the Bandage Harness invention Front Leg application, as it would look when placed on an animal's left front leg.

FIG. 5a is the left side view of the Bandage Harness invention Rear Leg application with the fitted harness, as it would look when placed on an animal's left rear leg.

FIG. 5b is the right side view of the Bandage Harness invention Rear Leg application with the fitted harness, as it would look when placed on an animal's left rear leg.

FIG. 6 is the top view of the Bandage Harness invention Front Leg application.

FIG. 7 is the top view of the Bandage Harness invention Rear Leg application with the fitted harness.

### DETAILED DESCRIPTION OF THE INVENTION

Referring to the drawings, the detailed description, and materials, detailed information about the invention is provided, including the description of specific aspects. The detailed description serves to explain the principle of the invention. The invention is susceptible to modifications and alternative forms. The invention is not limited to the particular forms disclosed. The invention covers all modifications, equivalents, and alternatives falling within the spirit and scope of the invention as defined by the claims.

Described below are examples of the present invention as it is used for an animal, in most cases a dog or cat, but not limited to that specific type of animal, that has injured it's leg, yet has not injured the paw. Prior inventions such as U.S. 2008/0173258, application Ser. No. 11/595,871 by Eunice Franco, the Protective Foot and Leg Cover Guard for Leg Wounds and Allergies, and U.S. 2008/0022945, application Ser. No. 11/880,053 by Jeffrey K. Hughes and Joshua P. Hughes, Leg Bandages for Animals, allow the opportunity for a leg wound to be covered with or without the use of the prior art of wrapping a leg wound with bandages, gauze, and tape that is used by Veterinarians. Unfortunately, due to an animal's natural instinct to clean a wound by licking at it, they do not allow proper protection. Some animals need the application of bandages as protection of the wound.

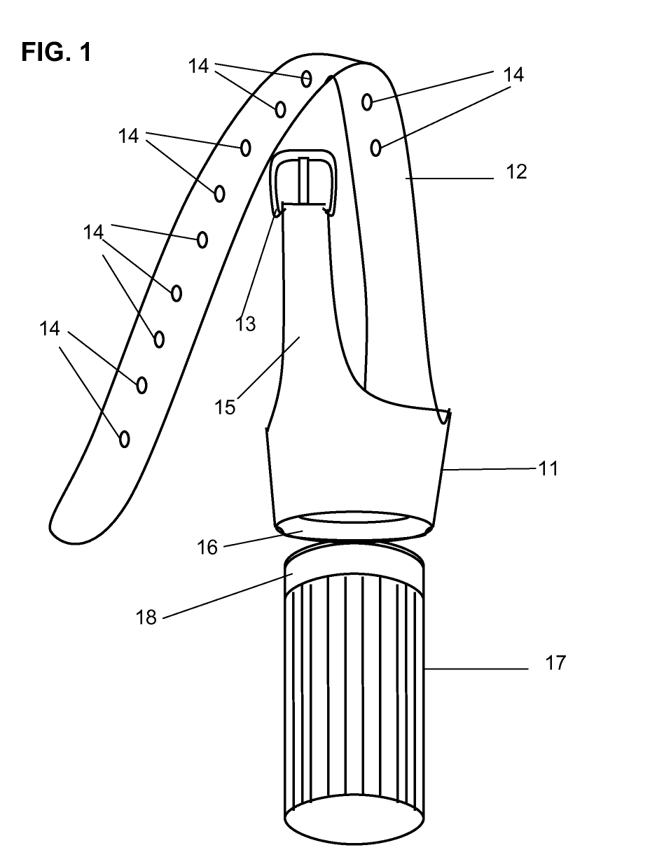

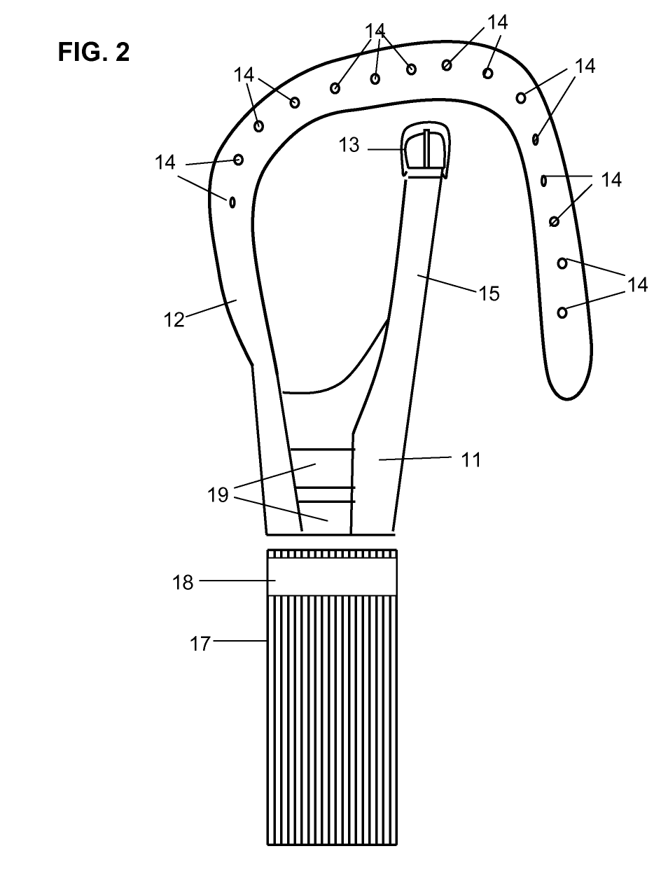

When an animal has a leg wound, it is usually wrapped from where the leg connects with the chest and encases the paw with thoughts that this type of wrapping will keep the bandage from falling down and uncovering the wound. It is encasing the paw, which is not injured, with bandages that usually causes the animal to bite at the bandage. When the paw of an animal is wrapped within bandages, it creates heat, moisture, and irritation to happen within the interdigits of the animal. This irritation causes an itching sensation and sometimes a sore or sores to occur within the interdigits, causing the animal to want to get to the irritation and calm the itching or clean the sores. Not only is the animal destroying the bandage by chewing at it, it is causing the bandage to unravel, come apart, and fall down exposing the wound for them to instinctively lick; it creates the possibility of a health concern if the animals ingests the bandages they are attempting to remove. The bandage harness invention FIG. 1 and FIG. 2, as described in detail below, allows the wound to be properly bandaged to allow protection and keeping the bandage in place while alleviating the need to encase the paw. It is machine washable and made per leg for a proper fitting which keeps the invention in place. Another advantage is that only one leg is needed for the invention, which allows this invention to work on animals that may have only two or three legs. It can also aid in the bandaging of an animal that has had an amputation of a leg, since it is actually the straps surrounding the chest that keep the bandage up.

Referring now to the drawings, particularly FIG. 1, which is an outside view of the bandage harness invention consists of a tubular body 11 that the animal's leg goes into and is fitted above the elbow. It can be made of a nylon or cotton canvas materials and can be washed to be re-used as needed. The top of the tubular body 11 extends into two straps 12 and 15. One strap 12, which is longer in length of the two straps, contains holes 14 connects with strap 15 with a buckle 13 to allow for the invention to be adjustable per the animal's girth. The detachable stockinet 17 connects to the bottom part of the tubular body 11 with Velcro or hook and loop fastener 16, the loop side, and 18, the hook side, is used to cover the medicated pad that covers the wound; therefore the gauze wrap and net wrap between the medicated pad and bandage is no longer needed, unless there is a reason to pad the wound for protection. This also allows the detachable stockinet 17 to be used once and discarded for proper sanitary use in protecting the wound from infection or not to be used at all. There are also situations that a Veterinarian may feel that the detachable stockinet 17 does not need to be used at all, therefore the reason to make the stockinet 17 a detachable feature.

In FIG. 2, is the inside view of the bandage harness invention. The inside view of the body 11 contains elastic straps 19 to allow for the proper and secure fitting of an animal's leg girth. These elastic straps 19 connect the tubular body 11 together allowing less material on the inside of the leg in order for the bandage harness invention to fit securely and comfortably within the crook where the leg and chest meet. Once again, straps 12 and 15 are connected with the buckle 13 on strap 15 and the holes 14 on strap 12 to allow for adjustability of the bandage harness invention. The bottom part of the tubular body 11 connects to the detachable stockinet 17 with the Velcro 16 and 18.

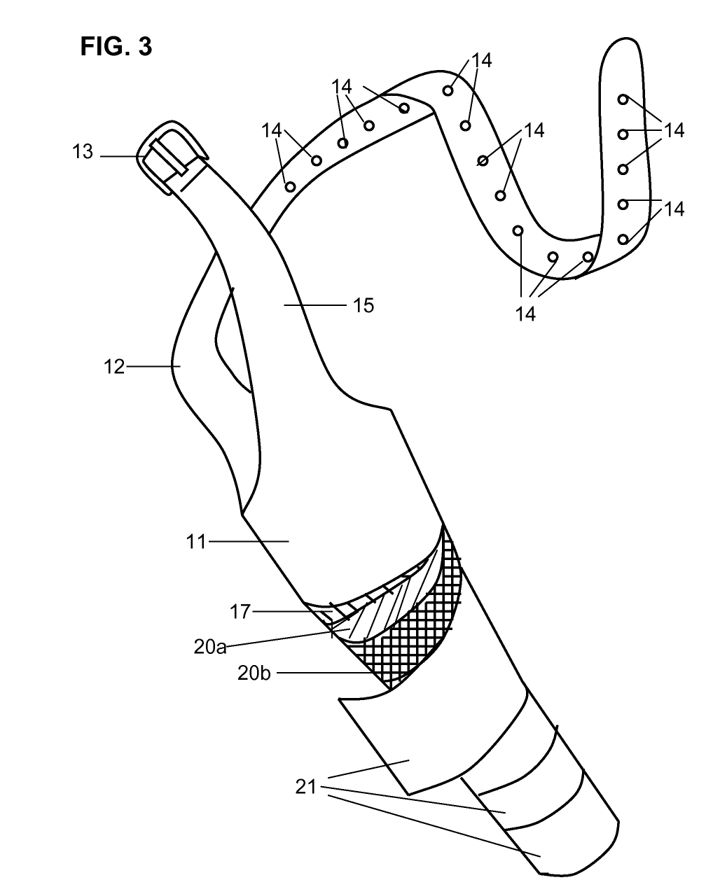

The art of wrapping the animal's leg with the bandage harness invention with the bandages that are used by Veterinarians is shown in FIG. 3. First the tubular body 11 with the detachable stockinet 17, which is attached to each other by Velcro, is fitted over the animal's leg over the medicated pad that covers the wound. The straps 12 and 15 are connected over the animal's withers or shoulder blades and connected with the buckle 13 into the proper hole 14 for a comfortable and secure fitting. If the gauze wrap 20a is used it is wrapped around the leg over the detachable stockinet 17 from the base of the tubular body 11 to the end of the detachable stockinet 17 or a desired length, as the stockinet can be folded up over the bandages or cut to a specific length. Then the netting wrap 20b, which keeps the gauze wrap 20a securely in place, is wrapped around the animal's leg on top of the gauze wrap 20a. Finally, the top bandage 21 is applied. The top bandage 21 is similar to an ace bandage used for sprains, yet it has a glue like substance on the inside in order to attach the top bandage 21 to the under wrapping 20a and 20b for a secure fit. When wrapping the top bandage 21, it is first attached onto the tubular body 11 so that the glue like substance is attached to the tubular body 11, no less than one inch of the base of the tubular body 11 then wrapped and attached to 20b, the net wrapping. The straps 15 and 12 and the tubular body 11 aid in keeping the bandage up as it is connected over the withers or shoulder blades with the straps 12 and 15 with the glue like substance of the top bandage 21 adhered to one inch, or more if desired, of the bottom of the tubular body 11 of the bandage harness invention. In the situation that the detachable stockinet 17 is not used, then the gauze wrap 20a would be applied over the bottom edge of the tubular body 11 covering the medicated pad over the wound. Then the netting wrap 20b would be applied over and wrapped around the gauze wrap 20a, with the top bandage 21 applied over the netting wrap 20b by first attaching it to the tubular body 11 above the gauze wrap 20a then wrapped down the leg to the desired length.

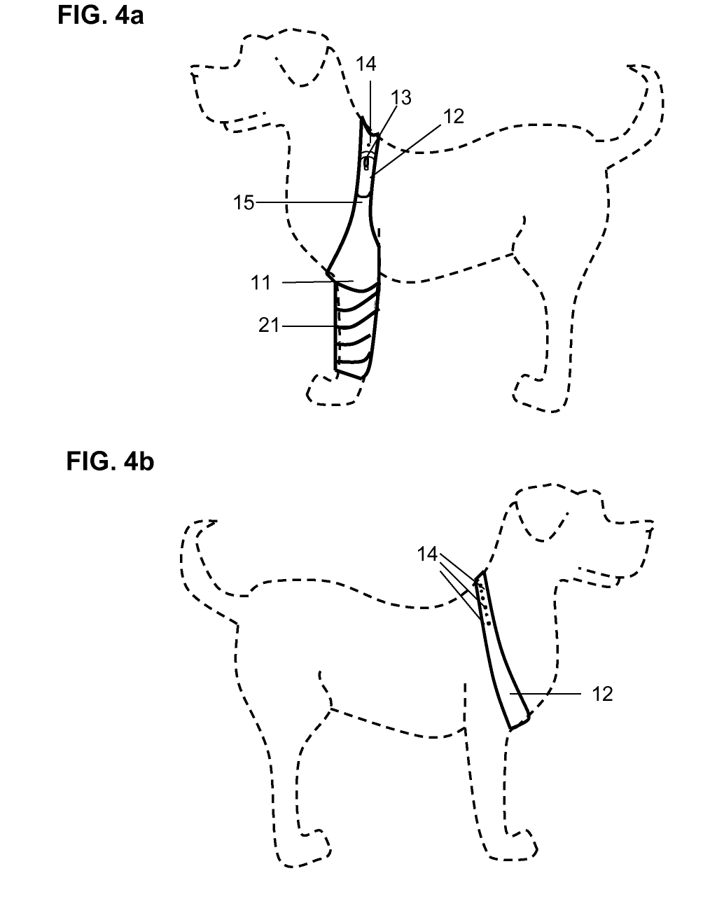

FIG. 4a shows the left side view of how the bandage harness invention would look when applied on the animal, in this case a dog. This view is the front leg application of the bandage harness invention. As shown the tubular body 11 is placed on the animal's leg and connected with the straps 12 and 15 by the buckle 13 and the holes 14 for a secure fit. The bandages, with the top bandage 21 shown, are then attached to the bottom part of the tubular body 11 with the underside of the top bandage 21 that contains the glue like substance. Shown in FIG. 4b is the right side view of how the bandage harness invention would look when applied on the animal's left front leg. The strap 12 comes from underneath, between the front legs, and across the chest, along the side of the neck, and goes over the withers or shoulder blades of the animal. Note the numerous holes 14 in strap 12 to allow for adjustability when fitted to the girth of the animal.

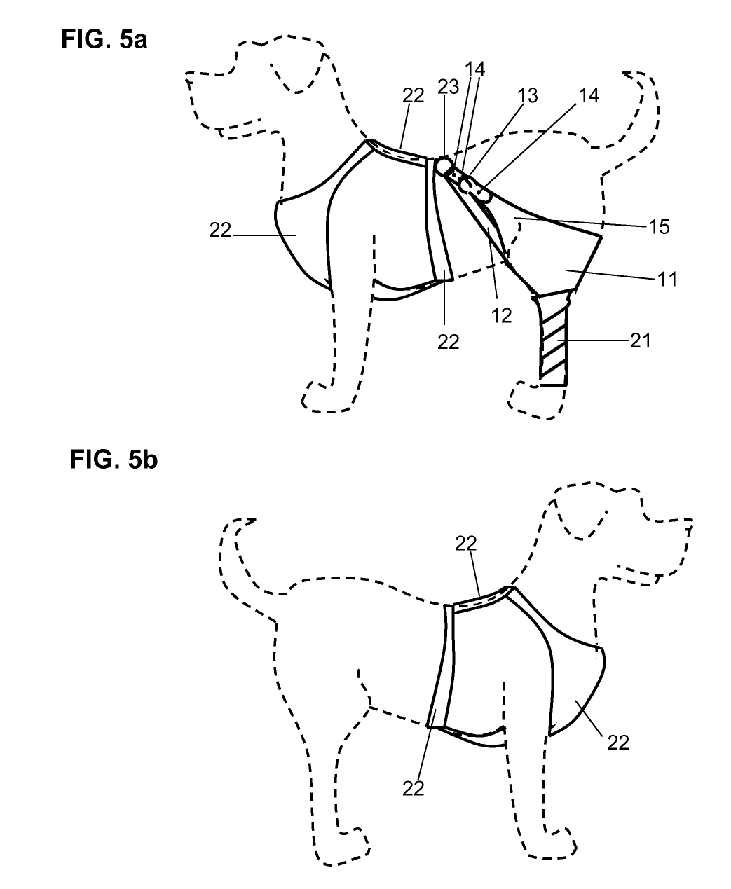

In the rear leg application, FIG. 5a shows the left side view of how the bandage harness invention would look when applied on the animal. In this view a harness is used in order to aid in the proper fit of the bandage harness invention as a rear leg application. The tubular body 11 is fitted over the rear leg, in this situation the rear left leg. It is then attached with strap 12 running from the underneath of the animal, coming up the same side of the leg that the bandage harness is on, going through a circular device 23 that is on the harness 22, normally used to attach a leash to it, and connecting with strap 15. The straps 12 and 15 are attached together with the holes 14 and buckle 13 for a secure fit. The bandages, with the top bandage 21 shown, are then attached to the bottom part of the tubular body 11 with the underside of the top bandage 21 that contains the glue like substance. It is very important that the harness used to attach the bandage harness invention to it, is a secure and snug fitted harness such as the Non-choking Harness, U.S. 2010/0263602, yet does not need to be this exact harness. Showing the right side view, FIG. 5b, is how the bandage harness invention would look when used as a rear left leg application. Note the harness 22 is the only item that can be seen as the bandage harness invention is used on the opposite leg, allowing the invention to be used on a dog with only one rear leg.

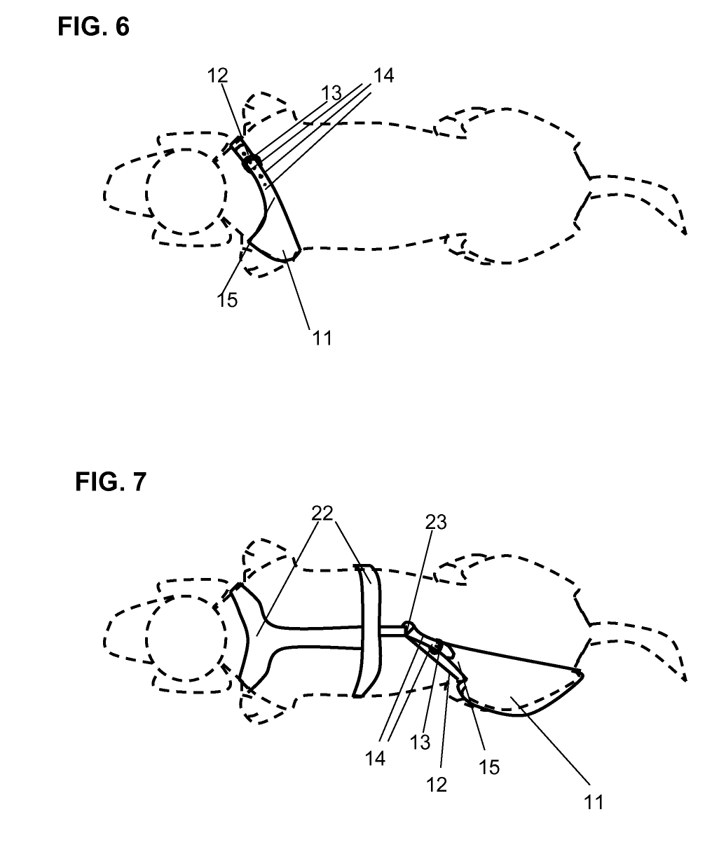

FIG. 6 shows the overhead view of the bandage harness invention used as a front leg application on the front left leg of an animal. The body 11 can be seen with straps 12 and 15 attached with the buckle 13 and holes 14 for a secure fit laying over the withers or shoulder blades of the animal.

FIG. 7 shows the overhead view of the bandage harness invention used as a rear leg application on the rear left leg of an animal. The tubular body 11 can be seen with straps 12 going through the circular device 23, normally used to attach a leash, of the harness 22. Strap 12 then connects with strap 15 by attaching the buckle 13 with a hole 14 that is on strap 12 for a secure fit.

The invention claimed is:

1. A bandage harness device for an animal with at least one leg that comprises of a tubular body, two straps, a buckle, and holes to connect the buckle to, and detachable stockinet.

2. The bandage harness for animal of claim 1 consists of a cotton base canvas material that is breathable, flexible, with little stretch, and is machine washable for reuse.

3. The tubular body of the bandage harness of claim 1 is formed from an flat piece of fabric and attached to connect the two parallel sides by elastic straps to allow for stretch and a snug and secure fit around the girth of an animal's leg.

4. The bandage harness for an animal of claim 1 consists of a tubular body that contains two straps parallel from each other though different in length that attach to each other.

5. The bandage harness for an animal of claim 4 whereas the straps connect to each other by a device consisting of a buckle apparatus. With one strap containing a buckle device and the other strap containing holes for adjustability per animal's girth of chest or attachment to a harness for rear leg application. The one strap with the holes is put through the buckle to a snug fit then the buckle finger is put into a hole.

6. The bandage harness for an animal of claim 1 contains a detachable stockinet that attaches to said tubular body in claim 1 at the bottom with a hook and loop fastener that is best known as Velcro. The loop fastener side is attached to the tubular body base on the inside and the hook side is fastened to the stockinet on the outside.

7. The detachable stockinet of the bandage harness for an animal in claim 6 can be used with the art of wrapping a wound or not used based on a Veterinarian's decision. The detachable stockinet can also be folded over the bandage wrapping or cut to desired length. The detachable stockinet can also be used and discarded then replaced with another detachable stockinet for sterile use against infections of the wound.

8. The bandage harness device for an animal of claim 1 is made per leg; front right leg, front left leg, rear right leg, rear left leg. It is made per leg for the proper secure and snug fit that ensures the bandage does not fall down and/or expose the wound during the normal activities of an animal.

9. The bandage harness device for an animal of claim 1 has a front leg application whereas the front leg with the wound is placed through the tubular body. The long inside strap is brought through the front legs, up the front of the chest, along the side of the neck to the top of the withers or shoulder blades. The shorter strap with the buckle is brought up the outside of the wounded leg, up the side of the chest and attached to the longer strap across the withers or shoulder blades for a snug and secure fit.

10. The bandage harness device for an animal of claim 1 has a rear leg application that consists of the use of a harness normally used on an animal in place of a collar, that is a snug and secure fit in order to keep the rear leg bandage harness securely in place.

11. For the rear leg application of the bandage harness device of claim 10 in conjunction with a harness of prior art, the rear leg is placed through the tubular body. The long strap that is on the inside of the bandage harness device is brought up from under the belly of the animal along the same side of the bandage harness, through the circular device of the harness that is normally used to attach the leash. The long strap is then attached to the smaller strap with the buckle for a secure fit.

12. The bandage harness device for an animal of claim 1 is made in a range of sizes; extra-small, small, medium, large, extra-large. Size varies due to circumference and length of leg for the tubular body and stockinet, and the length of straps and amount of holes in accordance to the size of the chest and girth of the animal.

13. The method of making the bandage harness for an animal with at least one leg of claim 1 is comprised of the following steps:
a—With use of a pattern per leg side, position, and size, the material is cut in one piece consisting of tubular body section and two straps, one strap ⅓ the length of the other.
b—The tubular body parallel sides are attached together with one to two elastic strips, one on top of the other with only one side touching each other.
c—A buckle attached to the end of the shorter strap.
d—On the longer strap, holes are placed the same distance apart, depending on size of bandage harness, and reinforced with grommets to deter tearing of fabric from wear.
e—One inch Velcro is place on the inside of the base of the tubular body with the loop side fastened to the inside of said tubular body.
f—A tubular stockinet cut to desired length per size of bandage harness, fastening the hook side of Velcro to the outside of one end that will attach to the inside of the tubular body base.

14. The method of applying the bandages to the wound with the application of the bandage harness of claim 1 may vary per Veterinarian, but in order to be used with the bandage harness the final top bandage with a glue like substance on one side must be attached to the base of the tubular body at least one inch, though may be placed on bandage harness higher for a more secure fit.

15. The bandage harness device of claim 1 can be made with basic canvas or made with material with patterns for more of a designer look; though the material can not have a lot of stretch in order to keep a secure and snug fit of the bandage harness when on the animal.
